(19) United States
(12) Patent Application Publication
(10) Pub. No.: US 2010/0173550 A1
(43) Pub. Date: Jul. 8, 2010

(54) METHOD OF MANUFACTURING NANOFIBER WEB

(76) Inventors: Young-Hwan Lee, Gyeongsangbuk-Do (KR); Hwan-Kwon Rho, Gyeongsangbuk-Do (KR); Jin-Hwan Choi, Gyeongsangbuk-Do (KR); Sang-Yoon Lee, Gyeongsangbuk-Do (KR)

Correspondence Address: BIRCH STEWART KOLASCH & BIRCH, PO BOX 747, FALLS CHURCH, VA, 22040-0747, US

(21) Appl. No.: 12/294,832

(22) PCT Filed: Mar. 28, 2007
(86) PCT No.: PCT/KR2007/001516

§ 371 Date: Dec. 1, 2008

(30) Foreign Application Priority Data
Mar. 28, 2006 (KR) 10-2006-0027720

(51) Int. Cl. D04H 3/08; B29C 47/00

(52) U.S. Cl. 442/414; 264/466; 977/961

(57) ABSTRACT

A method of manufacturing a nanofiber web using an electrospinning method is disclosed. The method comprises the steps of: supplying a polymer solution to the surface of a metal roller 10 with a direct current high voltage applied thereto; spinning the polymer solution supplied to the surface of the metal roller 10 toward a collector 40 of a metal plate with a direct current high voltage applied thereto having a different charge from that of the metal roller 10 to volatilize nanofibers, wherein the collector of the metal plate is located on the horizontal surface of the metal roller 10; and coating the volatilized nanofibers 70 on the collector 40.

This method can improve the uniformity of the web, make the management of a production process easier, freely change type of web to be produced, make the maintenance and repair of facilities convenient, and simplify the facilities.

### TECHNICAL FIELD

The present invention relates to a method of manufacturing a nanofiber web using electrospinning, and more particularly, to a method of manufacturing a nanofiber web using electrospinning, which can improve the uniformity of the web, make the management of a production process easier, and make the maintenance and repair of facilities convenient by spinning a polymer solution by using a rotating metal roller instead of a conventional nozzle.

Electrospinning is a relatively simple method to produce superfine denier fibers (hereinafter, referred to as “nanofibers”) having a diameter ranging from several tens to several hundreds of nanometers, which al ready made its first appearance in Germany in the 1930s. However, this method has not received much attention because there were some limits in commercialization with the technology of the time, however, some research began again in the 1970s and full-scale research began only of ter the year 2000.

In electrospinning, a high voltage of several thousands to several tens of thousands of volts is applied a polymer solution so as to apply a force of a tangent vector exceeding a surface tension of a solvent, so that a fine polymer jet is sprayed from the polymer solution and proceeds at a high speed toward an object having a charge opposite to the charge applied to the polymer solution. An ejected polymer jet is dispersed into a large number of microfibres and scattered. The diameter of the microfibers ranges from several tens to several hundreds of nanometers.

By using electrospinning, a nanofiber web as shown in FIG. 4 consisting of nanofibers having a thickness ranging from several tens to several hundreds of nanometers can be manufactured from a polymer solution, and high-performance products, such as high functionality clothes, a super-precision filter, material for cell culture (scaffold), etc. can be obtained by using the nanofiber web.

FIG. 4 is an electron micrograph of the nanofiber web.

### BACKGROUND ART

In order to commercially produce a nanofiber web, Korean Registered Patent No. 0412241, Korean Registered Patent No. 0422459, and Korean Laid-Open Patent No. 2005-15610 suggest a method for electrospinning a polymer solution through a plurality of nozzles.

Specifically, in the conventional method, as shown in FIG. 3, a polymer solution is supplied through a metering pump 2 to a plurality of nozzles 3 with a high voltage applied thereto, and then electrospun on a fiber base material located on a collector 4 with a high voltage applied thereto having a charge opposite to that of the nozzles, thereby producing a nanofiber web.

FIG. 3 is a schematic view of a conventional electrospinning process.

The conventional method provides excellent productivity and excellent uniformity as compared to the use of one nozzle. However, the conventional technique has a very high possibility of a defect caused by blocking of a nozzle as a plurality of nozzles are used, and has the inconvenience of removing the nozzles whenever necessary and washing them one by one. Further, because a high voltage of several thousands or several tens of thousands of volts is applied to each of the nozzles, an electric field at each nozzle exerts a mutual effect on the direction of a poly mer jet generated from the nozzles, which makes it difficult to obtain a uniform nanofiber web.

Moreover, drops of the polymer solution from the tip of the nozzle are differently formed depending on the type of polymer, the molecular weight of polymer, the viscosity of a solvent, and a temperature, etc. Thus, there is an inconvenience of changing the size of the nozzles in conformity with the drops of the polymer solution in order to acquire stable spinning properties when changing the type of polymer, a polymer solution, and a production speed. In order to optimize the size of the nozzles, a proper inner diameter, length and so on of the nozzles should be examined through a test, and nozzles conforming thereto should be prepared and installed, which requires a fairly long preparation time for the production of varieties of nanofiber webs.

Especially, in the case that downward nozzles are used, voltage in the nozzles is not completely uniform, and this may cause a serious problem, such as the defect that the polymer solution is dropped and gene rated on the base material. This may sharply decrease the performance of a product using a nanofiber web, which develops into a serious defect in the quality of a final product.

In order to solve this problem, in actual commercialized electrospinning facilities, the technique of aligning nozzles in a diagonal direction of a base material or aligning them in multiple layers so that they are reciprocal to each other is being employed. However, a plurality of nozzle should be washed one by one, and it is difficult to basically solve the problem of a mutual effect of a polymer jet caused by an electric field in the nozzles.

### DISCLOSURE OF INVENTION

The present invention has been developed for the purpose of solving the foregoing problems and thus it is an object of the present invention to largely improve the uniformity of a nanofiber web.

Another object of the present invention is to make product variety changes and process management easier in the production of a nanofiber web and make the repair and maintenance of facilities easier.

To this purpose, the present invention provides a new method of manufacturing a nanofiber web, which electrospins a polymer solution on a fiber base material located on a collector by using a rotating metal roller instead of a plurality of nozzles.

To achieve the above objects, there is provided a method of manufacturing a nanofiber web according to the present invention, comprising the steps of: supplying a polymer solution to the surface of a metal roller 10 with a direct current high voltage applied thereto; spinning the polymer solution supplied to the surface of the metal roller 10 toward a collector 40 of a metal plate with a direct current high voltage applied there to having a different charge from that of the metal roller 10 to volatilize nanofibers, wherein the collector of the metal plate is located on the horizontal surface of the metal roller 10; and coating the volatilized nanofibers 70 on the collector 40.

Hereinafter, a preferred embodiment of the present invention will now be described.

First, in the present invention, as shown in FIG. 1, a polymer solution being stored in a polymer solution main tank 30 is supplied to the surface of a metal roller 10, which rotates while having a high voltage applied thereto, through a pump 31.

The present invention is characterized in that: a polymer solution is sprayed in a transverse direction from the surface of a rotating metal roller 10, that is, toward a collector 40 of a metal plate located on the horizontal surface of the metal roller 10, rather than being spun from a plurality of nozzles located in a nozzle block in the conventional art.

The present invention can solve the problem of blocking the nozzles in the conventional art since a polymer solution is sprayed from the surface of the rotating metal roller 10 instead of nozzles, can omit a wash ing process of nozzles, and can overcome the inconvenience of mounting an electrode at each nozzle.

Further, the present invention can effectively prevent a drop phenomenon in which the polymer solution is dropped on a nanofiber web in a drop shape since the polymer solution is sprayed in a transverse direction as mentioned above, and can improve physical properties by minimizing the time of contact between a solvent contained in the polymer solution and nanofibers to be formed.

FIG. 1 is a schematic view showing a process of the present invent ion.

A polymer solution stored in a polymer solution main tank 30 is supplied and stored into a polymer solution bath 21 within an electrospinning body 20 through a pump 31 as shown in FIG. 2, and part of the metal roller 10 rotates immersed in the polymer solution 22 stored in the polymer solution bath 21, to thus supply the polymer solution to the surface of the metal roller 10.

FIG. 2 is a cross sectional view showing one example of supplying a polymer solution to the surface of a metal roller 10.

The polymer of the polymer solution may include any soluble fiber-forming polymer such as polyester, polyamide, polypropylene, polyethylene, polystyrene, cellulose, polyvinyl alcohol, polyvinyl acetate, polyvinyl chloride, etc.

Further, there is no limitation on the type of a solvent for dissolving a polymer material. The solvent is limited according to polymer, any kind of solvent can be used according to the polymer used to produce a nanofiber web. There is also no limitation on the method of manufacturing a polymer solution.

The concentration of the polymer solution ranges from a low concentration of less than 1% to a high concentration of not more than 50%.

Further, more than two types of polymers can be used simultaneously. It is possible to melt two or more types of different polymers in a solvent for use, and it is also possible to melt polymers of the same type having different characteristics such as molecular weight in a solvent for use.

Next, the polymer solution supplied to the surface of the metal roller 10 is sprayed toward a collector 40 of a metal plate with a high voltage applied thereto having a different charge from that of the metal roller 10, and then volatilized nanofibers 70 are coated on the collector 40, thereby producing a nanofiber web.

A fiber material or film 8 may be located on the collector 40.

The collector 40 is located on the horizontal surface of the metal roller 10, and moves at a constant linear speed.

The linear speed of the collector 40 is 0.5 to 100 cm/min, this is preferable to effectively adjust the density of nanofiber, the size of pores, and the thickness of a nanofiber web.

The surface of the metal roller 10 is made of gold, tungsten, stainless steel, and alloys thereof, more preferably, stainless steel coated with platinum.

The diameter, length and rotation speed of the metal roller 10 are not specifically restricted.

The rotation speed of the metal roller 10 is properly adjusted according to an applied voltage, the concentration and viscosity of the polymer solution and so on.

Preferably, the rotation speed of the metal roller 10 is 100 to 1,000 cm/min. If the rotation speed is lower than the above range, the productivity is degraded, and if the rotation speed is higher than the above range, the average diameter of nanofiber becomes too large, and beads may be generated on the web due to a drop phenomenon of the spinning solution.

The stress of the polymer solution supplied to the surface of the metal roller 10 with a high voltage applied thereto becomes higher in a normal vector direction, due to the high voltage, than the surface tension of the polymer solution, thereby forming a polymer jet.

The polymer jet faces the collector having the opposite charge, and the polymer jet maintains a jet state on the surface of the roller until a predetermined section is reached, and thereafter is volatilized as it is changed into nanofibers.

A voltage applied to the metal roller 10 and the collector 40, respectively, is preferably 30,000 to 90,000 volts (V).

If the voltage is less than the above range, the content of the solvent in the polymer has to be increased for electrospinning, which leads to a reduction in economic efficiency, and if the voltage is beyond the above range, the nanofibers may be damaged thereby degrading the physical properties thereof.

Meanwhile, the interval between the metal roller 10 and the collector 40 is preferably 80 to 450 mm.

If the interval is less than 80 mm, nanofibers are not formed well and there is a risk of fire caused by sparks. If the interval is greater than 450 mm, there may be a problem of applying a sufficient voltage to the metal roller 10 and the collector 40 in electrospinning.

As above, in the present invention, there is no inconvenience of washing and managing a plurality of nozzles one by one by using a metal roller instead of a plurality of nozzles, and there is no disadvantage that the uniformity of a nanofiber web is dependent according to the alignment of the plurality of nozzles. Further, there is no inconvenience of changing the inner diameter, length, etc. of the nozzles according to the type, viscosity and the like of the polymer to be used. This makes it easier to make production changes, and there is no nonuniformity of the nanofiber web caused by an electrostatic repulsive force between the nozzles caused by the use of the nozzles. Further, flaws of undissolved polymers are not dispersed on the base material as compared to a conventional electrospinning apparatus, thereby enabling a nanofiber web having almost no flaw to be obtained.

A standard deviation of permeability of the nanofiber web produced by the above-mentioned method is less than 500 g/m²/day, the average diameter of the nanofiber is 30 to 900 nm, and the permeability is 10,000 to 20,000 g/m²/day.

### ADVANTAGEOUS EFFECT

The present invention can improve the uniformity of the web and make the management of a production process easier.

Additionally, the present invention can make the maintenance and repair of facilities easier and simplify the facilities.

### BRIEF DESCRIPTION OF THE DRAWINGS

These and other features, aspects, and advantages of preferred embodiments of the present invention will be more fully described in the following detailed description with reference to the accompanying drawings. In the drawings:

FIG. 1 is a schematic view showing a process of the present invent ion;

FIG. 2 is a cross sectional view showing one example of supplying a polymer solution to the surface of a metal roller 10;

FIG. 3 is a schematic view of a conventional electrospinning process; and

FIG. 4 is an electron micrograph of a nanofiber web.

### EXPLANATION OF THE REFERENCE NUMERALS FOR THE MAIN PARTS OF THE DRAWINGS

| | |
|---|---|
| 10: rotating metal roller | 20: electrospinning body |
| 21: polymer solution bath | 22: polymer spinning solution |
| 1, 30: polymer solution main tank | |
| 2, 31: polymer solution supply pump | |
| 4, 40: collector | 6, 50: voltage generator |
| 60: earth | 70: nanofiber |
| 80: fiber base material or film | 3: nozzle block |
| 5: voltage transfer rod | |

### BEST MODES FOR CARRYING OUT THE INVENTION

The present invention will be described more fully by way of examples and comparative examples. The invention is not intended to be limited to the following examples.

### Example 1

Polyamide was dissolved in formic acid to have a concentration of 8% to prepare a polyamide solution at 25° C. and use it as a polymer solution.

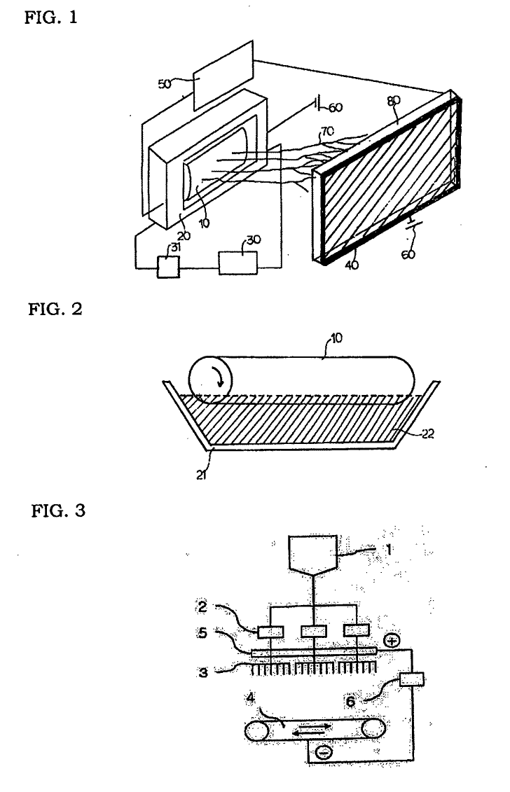

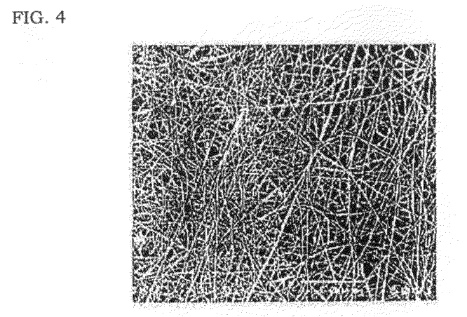

According to the process as shown in FIG. 1, a polyamide solution stored in a polymer solution main tank 30 was supplied to a polymer solution bath 21 within an electrospinning body 20 through a pump 31, and then part of a metal roller 10 having a high negative voltage applied thereto was immersed therein, and the metal roller 10 was rotated to supply a polyamide solution to the surface of the metal roller 10, and then the polyamide solution was sprayed toward a collector 40 of a metal plate having a high positive voltage applied thereto to volatilize nanofibers, and then the volatilized nanofibers 70 are coated on a polyester fabric passing over the collector at a speed of 0.5 m/sec, thereby producing a nanofiber web.

At this time, a voltage of 55,000 volts was applied to the metal roller 10 and the collector 40 by using a high voltage generator 50 connected to an AC power of 220 volts, 60 Hz.

The inside of the metal roller is made of stainless steel, the surface thereof is coated with platinum at a thickness of 2.5 mm, the length thereof is 45 cm, the diameter is 25 cm, and the rotation speed is 8 rpm.

The metal plate, which is the collector, has a width of 45 cm, a length 60 cm and a thickness of 0.5 cm.

The interval between the metal roller 10 and the collector 40 is set to 30 cm.

The results of evaluation of various physical properties of the fabric coated with the nanofiber web are as in Table 3.

### Examples 2 to 6

A nanofiber web was produced under the same conditions as Example 1 except that the type of polymer and solvent comprising a polymer solution, the voltage applied to a collector and a metal roller, the rotation speed of a metal roller, and the interval between the metal roller and the collector were changed as in Table 1.

The results of evaluation of various physical properties of the fabric coated with the nanofiber web are as in Table 3.

TABLE 1
Production condition of Examples 2 to 6

| | | | | | | Metal roller- |
|---|---|---|---|---|---|---|
| | | | | | | collector |
| | Electrospinning | | | | Roller rotation | interval |
| Subjects | apparatus | Type of polymer | Solvent | Voltage (volts) | speed (rpm) | (cm) |
| Example 1 | Metal roller | Polyamide | Formic acid | 55,000 | 8 | 30 |
| Example 2 | Metal roller | Polyurethane | Dimethylformamide | 35,000 | 10 | 30 |
| Example 3 | Metal roller | Polyamide | Formic acid | 70,000 | 8 | 45 |
| Example 4 | Metal roller | Polyurethane | Dimethylformamide | 50,000 | 10 | 45 |
| Example 5 | Metal roller | Polypropylene | Toluene | 40,000 | 8 | 30 |
| Example 6 | Metal roller | Polypropylene | Toluene | 60,000 | 8 | 45 |

### Comparative Example 1

Polyamide was dissolved in formic acid to have a concentration of 8% to prepare a polyamide solution at 25° C. and use it as a polymer solution.

According to the process as shown in FIG. 3 a polyamide solution stored in a polymer solution main tank 1 was supplied to a plurality of nozzles 3 having a high positive voltage applied thereto through a metering pump 2, and then the polyamide solution was sprayed toward a collector 4 of a metal plate having a high negative voltage applied thereto to volatilize nanofibers, and then the volatilized nanofibers are coated on a polyester fabric passing over the collector at a speed of 0.5 m/sec, there by producing a nanofiber web.

At this time, a voltage of 55,000 volts was applied to the plurality of nozzles 3 and the collector 4 by using a high voltage generator 50 connected to an AC power of 220 volts, 60 Hz, and the discharge amount of the nozzles was 0.5 ml/min.

The metal plate, which is the collector, has a width of 45 cm, a length 60 cm and a thickness of 0.5 cm.

The interval between the metal roller 10 and the collector 40 is set to 30 cm.

The results of evaluation of various physical properties of the fabric coated with the nanofiber web are as in Table 3.

### Comparative Examples 2 to 6

A nanofiber web was produced under the same conditions as Comparative Example 1 except that the type of polymer and solvent comprising a polymer solution, the voltage applied to a collector and nozzles, the discharge amount of the nozzles, and the interval between the metal roller and the collector were changed as in Table 2.

The results of evaluation of various physical properties of the fabric coated with the nanofiber web are as in Table 3.

TABLE 2
Production condition of Comparative Examples 2 to 6

| | | | | | Nozzle discharge | Nozzle-collector |
|---|---|---|---|---|---|---|
| | Electrospinning | | | Voltage | amount | interval |
| Subjects | apparatus | Type of polymer | Solvent | (volts) | (ml/min) | (cm) |
| Comparative | Nozzle | Polyamide | Formic acid | 55,000 | 0.5 | 30 |
| Example 1 | | | | | | |
| Comparative | Nozzle | Polyurethane | Dimethylformamide | 35,000 | 0.6 | 30 |
| Example 2 | | | | | | |
| Comparative | Nozzle | Polyamide | Formic acid | 70,000 | 0.7 | 45 |
| Example 3 | | | | | | |
| Comparative | Nozzle | Polyurethane | Dimethylformamide | 50,000 | 0.8 | 45 |
| Example 4 | | | | | | |
| Comparative | Nozzle | Polypropylene | Toluene | 40,000 | 0.5 | 30 |
| Example 5 | | | | | | |
| Comparative | Nozzle | Polypropylene | Toluene | 60,000 | 0.8 | 45 |
| Example 6 | | | | | | |

TABLE 3
Results of Evaluation of Physical Properties

| | Average | Standard deviation | |
|---|---|---|---|
| | permeability | of permeability | Flaws |
| Subjects | (g/m^{2/}day) | (g/m²/day) | (number) |
| Example 1 | 15,000 | 300 | 0 |
| Example 2 | 18,000 | 250 | 0 |
| Example 3 | 16,000 | 300 | 0 |
| Example 4 | 20,000 | 320 | 0 |
| Example 5 | 18,000 | 280 | 0 |
| Example 6 | 16,000 | 260 | 0 |
| Comparative Example 1 | 18,000 | 2,500 | 11 |
| Comparative Example 2 | 18,000 | 1,800 | 12 |
| Comparative Example 3 | 15,000 | 1,900 | 6 |
| Comparative Example 4 | 18,000 | 1,500 | 10 |
| Comparative Example 5 | 19,000 | 2,200 | 12 |
| Comparative Example 6 | 20,000 | 2,000 | 9 |

As shown in the above results of evaluation, the standard deviation of permeability of the fabric coated with a nanofiber web according to the examples is less than 500 g/m²/day, which is very uniform. Further, it was possible to obtain a nanofiber web having a very excellent quality without having any flaw on the nanofiber web.

However, in the comparative examples, the permeability is almost the same, and the standard deviation is greater than 2,000 g/m²/day, which is very high. Further, the number of flaws is 6 to 12, which is very high as compared to the nanofiber web of the examples. Flaws are mostly from the polymer solution dropped from the nozzles, and the nozzles may be blocked due to changes in type of web to be produced.

The physical properties of FIG. 3 were evaluated by the following method.

Permeability of Nanofiber Web

The permeability of the fabric coated with the nanofiber web of the examples and comparative examples was evaluated 10 times for different measurement regions, and the average value and standard deviation thereof were obtained. A permeability estimation method is to apply moisture to a fabric at a constant pressure, and after 24 hours, to evaluate grams of the passed moisture, which conforms to Korean Industrial Standard KS K 0594.

Flaw of Nanofiber Web

The number of flaws within the width of 45 cm and length of 5 m is determined by a naked eye inspection. Flaws are evaluated by the number of points where the polymer solution is dropped and the number of points where the nanofiber is not coated.

### INDUSTRIAL APPLICABILITY

The nanofiber web produced according to the present invention is useful for high performance filters, optical materials, etc.

1. A method of manufacturing a nanofiber web comprising the steps of:
supplying a polymer solution to the surface of a metal roller 10 with a direct current high voltage applied thereto;
spinning the polymer solution supplied to the surface of the metal roller 10 toward a collector 40 of a metal plate with a direct current high voltage applied thereto having a different charge from that of the metal roller 10 to volatilize nanofibers, wherein the collector of the metal plate is located on the horizontal surface of the metal roller 10; and
coating the volatilized nanofibers 70 on the collector 40.

2. The method of claim 1, wherein the collector 40 moves at a constant linear speed.

3. The method of claim 2, wherein the collector 40 moves at a linear speed of 0.5 to 100 cm/min.

4. The method of claim 1, wherein the surface of the metal roller 10 is made of one selected from the group consisting of gold, tungsten, stainless steel, and alloys thereof.

5. The method of claim 1, wherein a fiber material or film 80 is located on the collector 40.

6. The method of claim 1, wherein a voltage of 30,000 to 90,000 volts (V) is applied to the metal roller 10 and the collector 40, respectively

7. The method of claim 1, wherein the horizontal distance between the metal roller 10 and the collector 40 is 80 to 450 mm.

8. The method of claim 1, wherein the rotation speed of the metal roller 10 is 100 to 1,000 cm/min.

9. A nanofiber web comprising nanofibers, which is produced by the production method of claim 1, wherein the standard deviation of permeability is less than 500 g/m²/day, the average diameter of the nanofibers ranges from 30 to 900 nm, and the permeability ranges from 10,000 to 20,000 g/m²/day.
